(19) United States
(12) Patent Application Publication
(10) Pub. No.: US 2017/0354290 A1
(43) Pub. Date: Dec. 14, 2017

(54) Preparation of Heated Beverages

(71) Applicant: Curt Jones, Brentwood, TN (US)

(72) Inventor: Curt Jones, Brentwood, TN (US)

(21) Appl. No.: 15/180,607

(22) Filed: Jun. 13, 2016

(51) Int. Cl. A47J 31/46; A47J 31/52; A23F 3/18; A23F 5/26

(52) U.S. Cl. CPC A47J 31/465; A23F 5/26; A47J 31/52; A23F 3/18

(57) ABSTRACT

A beverage maker, including a receiver including a hollow body with an interior surface and an exterior surface, wherein the hollow body is configured to retain contents, a reservoir configured to retain fluid, a fluid transfer configured to transfer fluid from the reservoir to the receiver, a heating element in thermal communication with at least one of the reservoir and the receiver, and at least one pipe configured to receive contents from the receiver, wherein the at least one pipe is configured to dispense the contents from the beverage maker.

### CROSS-REFERENCE TO RELATED APPLICATION

This application is a nonprovisional utility application claiming priority benefit to U.S. Provisional Patent Application 62/173,993, filed on Jun. 11, 2015. The entire contents and disclosures of the above application is incorporated herein by reference.

### FIELD OF THE INVENTION

The present invention relates to preparing a heated beverage from a frozen comestible mix.

### BACKGROUND OF THE INVENTION

Several coffee makers exist on the market, including specialty instant single serve coffee makers. However, these products require coffee filters or small cups, which must be discarded as refuse after use. These coffee filters and cups collect in landfills and degrade over time, thus causing harm to the environment. Furthermore, current coffee makers use ground coffee beans that are typically stored at room temperature. Over time, the coffee beans and/or grounds may spoil or degrade and lose flavor.

Additionally, some tea makers exist on the market, which including specialty tea presses. However, these products require a trap for retaining tea leaves, and these traps must be cleaned before reuse. Furthermore, current tea makers use tea leaves that are typically stored at room temperature. Over time, the tea leaves may spoil or degrade and lose flavor.

### SUMMARY

Embodiments of the present invention relate to a beverage maker, including a receiver including a hollow body with an interior surface and an exterior surface, wherein the hollow body is configured to retain contents, a reservoir configured to retain fluid, a fluid transfer configured to transfer fluid from the reservoir to the receiver, a heating element in thermal communication with at least one of the reservoir and the receiver, and at least one pipe configured to receive contents from the receiver, wherein the at least one pipe is configured to dispense the contents from the beverage maker.

Further embodiments of the present invention relate to a method of making a heated beverage, including retaining a frozen comestible mix in a receiver such that the frozen comestible mix becomes at least part of a contents of the receiver, heating the contents of the receiver, and dispensing the heated contents through an output pipe.

### BRIEF DESCRIPTION OF THE DRAWINGS

Various aspects of the present invention are illustrated by way of example, and not by way of limitation, in the accompanying drawings, wherein;

FIG. 1 depicts a block-level diagram of preparation of a heated beverage from a frozen comestible mix in accordance with the principles of the present invention.

FIG. 2 depicts a diagram of structure of an embodiment of a beverage maker in accordance with the principles of the present invention.

FIG. 3 depicts a block-level diagram of a controller in accordance with the principles of the present invention.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a controller, a general purpose computer, a special purpose computer, or other programmable data processing apparatus to produce a machine, such that the instructions, which executed via the processor of the controller or other programmable data processing apparatus, create means for implementing the functions/acts specified in the flowchart and/or block diagram block or blocks.

These computer program instructions may also be stored in a computer readable medium that can direct the controller, the computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto the controller, a computer, other programmable data processing apparatus, or other devices to cause a series of operational steps to be performed on the controller, other programmable apparatus or other devices to produce a controller implemented process such that the instructions which execute on the controller or other programmable apparatus provide processes for implementing the functions/acts specified in the flowchart and/or block diagram block or blocks.

The following description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a method, system, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product on a computer-usable storage medium having computer-usable program code embodied in the medium.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Aspects of the invention were chosen and described in order to best explain the principles of the invention and the practical application, and to enable others of ordinary skill in the art to understand the invention for various embodiments with various modifications as are suited to the particular use contemplated.

For the purposes of the present disclosure, “frozen comestible mix” refers to a frozen mixture that can be thawed, or thawed and diluted, into a potable beverage. Examples include a frozen coffee mix that can be used to form coffee, a frozen tea mix that can be used to form tea, etc.

In some embodiments, the frozen comestible mix may be prepared by freezing a liquid comestible mix formed from boiling corresponding ingredients. The liquid comestible mix may comprise coffee liquid mix, tea liquid mix, etc. For example, the frozen coffee mix may be prepared by freezing a coffee liquid mix formed from boiling coffee beans and/or grounds. In some embodiments, the coffee beans may be roasted before forming the coffee liquid mix. Additionally, the frozen tea mix may be prepared by freezing a tea liquid mix formed from boiling tea leaves, fruit, and/or other ingredients.

Freezing the liquid comestible mix may include dripping the liquid comestible mix into cryogenic liquid, such as liquid nitrogen, such that the frozen comestible mix comprises frozen comestible beads. Furthermore, the frozen comestible beads may be pourable. Examples of the procedures and structures useful to form frozen comestible beads may be similar to the procedures and structures useful to form cryogenically frozen beads as can be found in U.S. Pat. No. 6,000,229, which is fully incorporated herein by reference.

The frozen comestible beads are not identical to the cryogenically frozen beads of the publication identified above. The alimentary liquid composition and corresponding cryogenically frozen beads of the above reference are disclosed to include ice cream formulations and ice cream, respectively. The liquid comestible mix and the frozen comestible beads are not ice cream, as defined by the U.S. standards for ice cream. Specifically, Title 21, Chapter 1, Subchapter B, Part 135, Subpart B, Sec. 135.110 addresses the requirements for a frozen dessert to be marketed as “ice cream.” Sec. 135.110 requires that ice cream contain not less than 10 percent milk fat. However, frozen comestible beads of 10 percent or greater milk fat may not necessarily produce a heated beverage having a tolerable taste and/or mouthfeel. Therefore, the liquid comestible mix may comprise less than 10 percent milk fat by weight and by mass. Furthermore, the frozen comestible beads may comprise less than 10 percent milk fat by weight and by mass.

Heated beverages, such as coffee and tea, may be brewed beverages having distinct respective aromas and flavors. Coffee may be prepared from roasted coffee beans, which are seeds that may be found inside berries of the coffea plant. However, coffee could be made from other coffee plants. Embodiments of the present invention may provide for the preparation of coffee by heating and/or dilution of a frozen comestible mix, such as a frozen coffee mix. Therefore, the preparation of the coffee from the frozen coffee mix can be accomplished without the use of filters or K-cups, thereby reducing the waste generated from coffee preparation by the consumer.

In addition, traditional tea may comprise a brewed drink prepared by infusing the dried, crushed leaves of the tea plant, Camellia sinensis, in hot water. Camellia sinensis may be a sub-tropical evergreen plant native to Asia but now grown around the world. This plant may grow best in loose, deep soil, at high altitudes, and in sub-tropical climates. Tisanes include drinks prepared by infusing at least one of chamomile, rooibos, and fruit in hot water. Herbal teas can include drinks prepared by infusing one or more of any plant with leaves, seeds, or flowers that can be used for flavoring, food, medicine, or perfume with hot water. Therefore, the term “tea” as used in this application refers to traditional tea, tisanes, herbal tea, or any combination thereof. Of course, boiling the water may allow faster preparation of tea and may allow more complete dissolution of components of the herb leaves into the tea. “Tea leaves” as used in this application refers to the leaves of any herb used to prepare traditional teas, tisanes, or herbal teas.

Embodiments of the present invention may provide for the preparation of tea from the frozen comestible mix, such as a frozen tea mix. The tea may be prepared by heating and/or dilution of the frozen tea mix. Because this preparation of tea can be accomplished without the use of filters or tea leaves, the time required and waste produced can be reduced for tea preparation by consumers.

Embodiments of the present invention may allow preparation of fixed volumes of the heated beverage, such as an individual cup, or a full pot, comprising several cups of tea, coffee or other heated beverage. Additionally, the frozen comestible mix may be used to prepare the heated beverage of the present invention. Furthermore, the frozen comestible mix, such as the frozen coffee mix and/or the frozen tea mix, may be packaged in a biodegradable package, such as a paper packet.

Furthermore, the frozen comestible mix may be stored longer without degradation of the components than the corresponding ingredients. For example, the frozen coffee mix may be stored longer than liquid coffee, dried coffees, dried coffee beans, or dried coffee grounds stored at room temperature. Additionally, the frozen tea mix may be stored longer than liquid tea, tea leaves, dried tea leaves, or cut or ground tea leaves stored at room temperature. In fact, the shelf life of the frozen comestible mix, frozen coffee mix, and/or frozen tea mix may be multiple years. Therefore, the frozen comestible mixes may be packaged and labeled with the year, the crop location, the blend, and/or any other identifying information. Certain years, crop locations, and blends may be more desirable and thereby price discrimination may be utilized to distinguish between frozen comestible mixes of various desirability. Furthermore, secondary markets may develop for the various frozen comestible mixes as multiple years pass and specific years are found desirable. The “blend” can refer the type(s) and ratio, if any, of coffee grounds, tea leaves, fruit, or other ingredients used to prepare the liquid comestible mix. “Blend” may also refer to the strength of the components of the liquid comestible mix, such as the concentration derived from boiling the components longer or at a higher temperature.

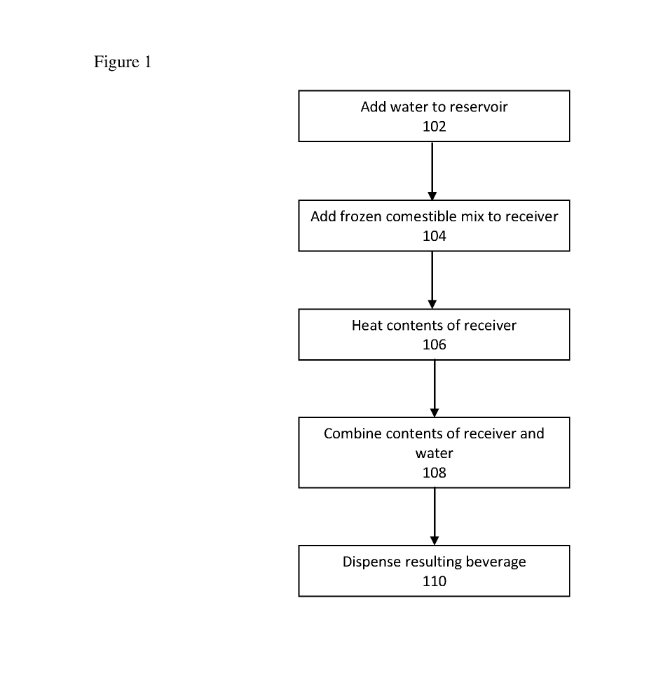

Looking to FIG. 1, embodiments of the present invention may utilize frozen comestible mix in the preparation of a heated beverage. For example, the heated beverage may be prepared with the aid of a beverage maker. When the beverage maker is used to prepare coffee, the beverage maker may be referred to as a coffee maker. When the beverage maker is used to prepare tea, the beverage maker may be referred to as a tea maker. Embodiments of the present invention include the method disclosed with respect to FIG. 1, including variations including removing and/or rearranging one or more steps.

In step 102, water may be added to a reservoir of a beverage maker. The water may be heated to a predetermined temperature before adding to the reservoir. Alternatively, the water may be added to the reservoir and then heated in the reservoir by one or more heating elements. Additionally, any sequence of heating and adding water to the reservoir may be performed.

In some embodiments, water may be added to the reservoir via a handheld container. Alternatively, the reservoir may be hooked to plumbing via a water line for the addition of water to the reservoir. Thus, a valve may be used to add water manually, or a sensor may detect the water level and automatically signal to add water when the level is below a predetermined water level of the reservoir.

In step 104, the frozen comestible mix can be added to a receiver of a beverage maker. For example, the frozen comestible mix can be added directly to the receiver from a package. Alternatively, the frozen comestible mix can be added to the receiver directly from a freezer. In these embodiments, the receiver can be configured such that the frozen comestible mix can be added to the receiver by the operation of gravity. For example, a pipe allowing frozen comestible mix beads can connect the freezer to the receiver. The beads can roll and/or flow through the pipe to the receiver, when the pipe is opened.

It may be desirable to serve the beverage through the output pipe after heating to a predetermined serving temperature. Thus, the contents of the receiver may be heated, as in step 106. The predetermined serving temperature may be received by user input before serving the heated beverage. For example, a heating element of the receiver may heat the contents of the receiver until a sensor of the receiver detects the predetermined serving temperature.

The heating the contents of the receiver, as in step 106, may be accomplished multiple ways. For example, the contents of the receiver may be heated directly or indirectly by a heating element in thermal communication with the contents of the receiver. Alternatively, in embodiments comprising heated water in the reservoir, the heated water may be combined with the contents of the receiver, as in step 108. This may raise the temperature of the contents of the receiver and may further dilute the contents of the receiver.

As an example of indirectly heating the contents of the receiver, water may be added to a reservoir that at least partially surrounds the receiver, and the water may be heated to a predetermined temperature, as is optional in connection with step 102. Furthermore the receiver may be heated by thermal conduction from the reservoir to the receiver. In some embodiments, the water may be added to the reservoir and heated to the predetermined temperature before addition of the frozen comestible mix to the receiver such that heating the frozen comestible mix occurs upon the addition of the frozen comestible mix to the receiver.

Upon heating the receiver to a predetermined temperature sufficient to warm a corresponding predetermined amount of frozen comestible mix, the frozen comestible mix may be added to the receiver and the contents of the receiver heated to a desired temperature. The predetermined temperature of the contents of the receiver may be verified by sensing the temperature of the contents of the receiver, such as by a thermometer.

Upon liquefaction of the contents of the receiver, the heated beverage may be formed in the receiver. However, the heated beverage may be further heated to a predetermined temperature. In some embodiments, the predetermined temperature may range from 91° C. to 96° C. Furthermore, embodiments include the predetermined temperature to be about 96° C. The heated beverage may be further diluted to a predetermined concentration. The predetermined temperature of the water in the reservoir may be determined based on the predetermined amount of frozen comestible mix, a starting temperature, and a specific heat of the frozen comestible mix and/or contents of the receiver, and the predetermined serving temperature of the heated beverage. The predetermined amount of frozen comestible mix may be determined by a concentration of the frozen comestible mix and the desired serving concentration of the resulting heated beverage. In step 108, water from the reservoir may be combined with the contents of the receiver. In some embodiments, the added water from the reservoir may be preheated. This combination may liquefy any frozen comestible mix in the contents of the reservoir. Alternative embodiments of step 108 include dispensing the contents of the receiver and then dispensing water. Thus, combining water with the contents of the receiver may not necessarily occur in the receiver, but could occur in any structure of the beverage maker that the contents of the receiver enters. Furthermore, the water and contents of the receiver may be mixed in the pot or cup by dispensing each separately.

The addition of water may further dilute the contents of the receiver to the serving concentration and heat the resulting heated beverage to the serving temperature. For example, the water content of the liquid comestible mix may be reduced before cryogenically freezing the liquid comestible mix. For instance, half the volume of water may be removed before cryogenically freezing the liquid comestible mix. Thus, water from the reservoir may be added back in the amount of the previously reduced volume of water. Therefore, the resulting heated beverage may comprise the concentration of the liquid comestible mix.

During the heating process, hot water, such as from the reservoir, may be added to the receiver to aid in heating the frozen comestible mix. Based on the amount of water added, the contents of the receiver and hot water may be combined to dilute the contents to a serving concentration in the receiver. The serving concentration may be greater or less than the concentration of the corresponding liquid comestible mix. Alternatively, the contents of the receiver may remain at a higher concentration than the serving concentration and the contents may be diluted to the serving concentration when combined with water at the output pipe. The resulting heated beverage may then be dispensed to a cup or pot, in step 110. Additionally, water may be added from an external source, such as a water line connected to a plumbing system.

The frozen coffee mix may comprise any frozen combination of coffee-based liquid, coffee, coffee solids, coffee additives, such as cream and sugar, and water. One, multiple, or all of the constituents of the frozen coffee mix may not be frozen when added to the receiver. Additionally, the constituents may be added from a single packet or from multiple packets or packages. In some embodiments, the liquid comestible mix may comprise coffee-based liquid. The coffee-based liquid may be prepared by brewing coffee beans or grounds. The coffee-based liquid may be further dehydrated until the concentration is increased above the serving concentration. This coffee-based liquid may be dripped into liquid nitrogen to form cryogenically frozen beads. These cryogenically frozen beads may form the frozen coffee mix. Alternatively, the cryogenically frozen beads may be further combined with other coffee blends, flavorings, creamers, sugar, etc. to form the frozen coffee mix. Furthermore, the coffee liquid may be concentrated before dripping such that the resulting frozen coffee mix may be diluted with hot water later while retaining a potent taste and mouthfeel. Further detail regarding production of the frozen coffee mix may be found in U.S. application Ser. No. 12/462,893 to Jones published as US20100034949 A1, the entire contents of which are hereby incorporated by reference.

The frozen tea mix may comprise any frozen combination of tea-based liquid, tea, tea solids, tea additives, such as one or more of cream and sugar, honey, and water. One, multiple, or all of the constituents of the frozen tea mix may not necessarily be frozen when added to the receiver. Additionally, the constituents may be added from a single packet or from multiple packets or packages. In some embodiments, the liquid comestible mix may comprise tea-based liquid. The tea-based liquid may be prepared by brewing tea leaves or grounds. The tea-based liquid may be further dehydrated until the concentration is increased above the serving concentration. This tea-based liquid may be dripped into liquid nitrogen to form cryogenically frozen beads. These cryogenically frozen beads may form the frozen tea mix. Alternatively, the cryogenically frozen beads may be further combined with other tea blends, flavorings, creamers, sugar, honey, etc. to form the frozen tea mix. Furthermore, the tea-based liquid may be concentrated before dripping, such that the resulting frozen tea mix may be diluted with hot water. Thus, the diluted frozen tea mix may retain a potent taste and mouthfeel. Further detail regarding production of the frozen tea mix may be found in U.S. application Ser. No. 12/806,397 to Jones published as US 20110039009 A1, the entire contents of which are hereby incorporated by reference.

As used herein, steam means gaseous water, such as may be produced by boiling. Boiling water means water at or above the boiling temperature of water. Hot water means water between room temperature and boiling temperature. Warm water means water at room temperature. Cool water means water below room temperature. Room temperature, as used in this application, means 20° C.

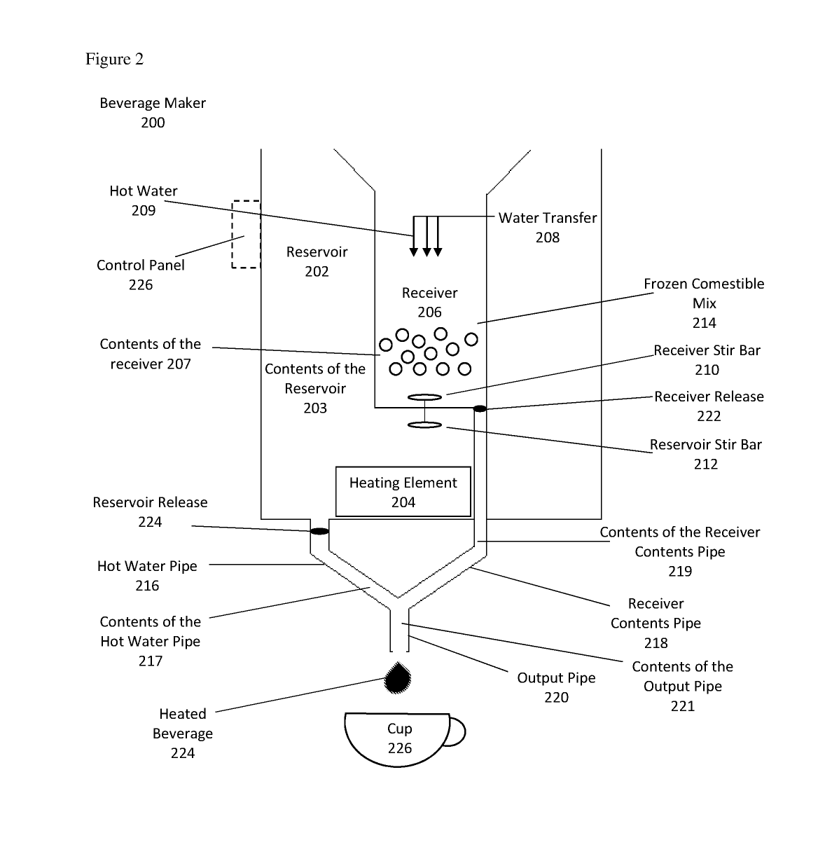

FIG. 2 illustrates an embodiment of a beverage maker 200 for preparing a heated beverage 224 from a frozen comestible mix 214 as described in relation to the process of FIG. 1. A reservoir 202 may comprise any shape and size sufficient for receiving and retaining a volume of water for heating a receiver 206. In some embodiments, the reservoir 202 is positioned around the receiver 206, such that the reservoir 202 may at least partially surround the receiver 206. Furthermore, the distance from the outside of the receiver 206 to the inside of the reservoir 202 may be at least one millimeter, one centimeter, or any distance sufficient to retain a volume of hot water for heating the receiver 206. The material of the reservoir 202 may comprise any material or combination of materials capable of retaining structural integrity of the reservoir 202 while the reservoir 202 retains, cool, warm, hot, or boiling water, or steam. For example, wood, glass, rubber, plastic, stoneware, etc. may be used. Furthermore, the material of the reservoir 202 may be sufficiently insulative such that the exterior of the beverage maker 200 does not reach a temperature that could cause harm if touched by a person. Additionally, the reservoir 202 may be sealed such that steam from boiling water does not escape from the top of the reservoir 202.

The water of the reservoir 202 may be heated by a heating element 204. Such a heating element 204 could be an electrical resistor that generates heat when an electric current is applied. The heating element 204 may be electrically coupled with a thermometer such that the heating element 204 may be turned on and off such that a predetermined temperature of the reservoir water may be reached or maintained. The heating element 204 may be positioned partially or completed under the receiver 206 such that rising heated water may heat the outside of the receiver 206.

The reservoir 202 may comprise a reservoir stir bar 212, which may aid in uniformly heating the water of the reservoir 202. The reservoir stir bar 212 may mix or stir the contents of the receiver 203, which may allow transfer of heat uniformly throughout the contents 203 and thus may allow faster heating of the contents 203. The contents 203 may comprise water. The reservoir stir bar 212 may pivot about an axle or may be manipulated magnetically, wherein revolving magnets in the reservoir 202 interact with magnets in the reservoir stir bar 212. Furthermore, the reservoir stir bar 212 may be driven mechanically by the axle. Additionally, the reservoir stir bar 212 may comprise a sufficient size and shape to stir the contents 203.

In some embodiments, the reservoir 202 contains and heats water. This water may then be used to heat the frozen comestible mix 214. However, other embodiments may contain other materials in the reservoir 202 such as aqueous solutions, organic solvents, thermally conductive gels, etc. Additional embodiments may merely include a heating element 204 against the receiver 206 such that the receiver 206 is heated directly and thereby the contents of the receiver 207 are heated.

The reservoir 202 may surround a portion or all of the receiver 206, such that heat transfer from the hot water in the reservoir 202 may melt and heat the frozen comestible mix 214 of the receiver 206. The receiver 206 may comprise any material capable of retaining structural integrity, receiving frozen comestible mix 214, and retaining liquid contents of the receiver 207. Part or all of the receiver 206 may comprise a material that is heat conductive, such as metal, certain plastics, a thin insulator, such as rubber, stoneware, etc. The receiver 206 may comprise an insulator at the opening such that the receiver 206 is safe to open.

The receiver 206 may comprise any shape sufficient for heat transfer from the water to the contents 207. For example, the receiver 206 may have a flat bottom, cylindrical body, and frusto-conical opening. However, shapes that maximize the ratio of surface area to volume of the receiver 206 may maximize heat transfer to the frozen comestible mix 214 or other contents 207. Such shapes may include spherical, hemispherical, cubic, rectangular prismatic, tetrahedral, etc. bodies having an opening for receiving the frozen comestible mix 214.

The receiver 206 may comprise a receiver stir bar 210, which may aid in melting the frozen comestible mix 214 and heating the contents 207. The receiver stir bar 210 may mix or stir the contents 207, which may allow transfer of heat uniformly throughout the contents 207 and thus may allow faster heating. Rotation of the receiver stir bar 210 may be similar to that of the reservoir stir bar 212. The receiver stir bar 210 may pivot about an axle or may be magnetic. Furthermore, the receiver stir bar 210 may be driven by electricity. Additionally, the receiver stir bar 210 may comprise a sufficient size and shape to stir the contents 207.

Furthermore, a water transfer 208 may be present in the receiver 206. The water transfer 208 may draw water from the reservoir 202 and transfer the water into the receiver 206 such that the transferred water becomes part of the contents 207 and thus may heat the contents 207. Alternatively, the water transfer 208 may transfer water into the receiver 206 from a source external to the beverage maker 200.

The water transfer 208 may be positioned such that water may be gravity fed from the reservoir 202 through the water transfer 208 to the receiver 206. The water transfer 208 may comprise a simple hole positioned such that weight of water above the hole in the reservoir 202 drives the water flow into the receiver 206. Alternatively, the water transfer 208 could comprise an electric, pneumatic, or hydraulic solenoid valve such that the flow of water may be controlled. Alternatively, a receiver release 222 may comprise a pump to pull water from the reservoir 202 to the receiver 206. In embodiments wherein the water transfer 208 is pressurized, the water transferred may be pressure sprayed onto the interior of the receiver 206 for removing the contents 207. Thus, water transfer 208 can be used to clean the receiver 206.

In some embodiments, the water transfer 208 may comprise any of a pressure sensor and a volume sensor. The pressure sensor may measure the pressure of water inside the water transfer 208. The volume sensor may measure the volume of water transferred by the water transfer 208. Alternatively, the volume sensor may measure the volume of contents 207. Such a volume sensor may comprise a magnetic level gauge, magnetorestrictive, radiofrequency (RF) transmitter, radar, ultrasonic, magnetic switch, float switch, RF switch, vibrating fork, thermal dispersion, seal pot, or other sensors.

A thermometer may be placed such that the temperature of the water in the reservoir 202 is measured. For example, the thermometer may be placed just outside the water transfer 208. This position can be useful in determining when the temperature of the water in the reservoir has reached the predetermined temperature for transfer to the receiver 206. The temperature control could be used to prevent the water transfer 208 from transferring water until the water in the reservoir 202 reaches a predetermined temperature. Furthermore, a volume sensor may measure the amount of water that has passed through the water transfer 208 for each serving volume of the heated beverage, such as coffee and/or tea, and may stop the water flow once a predetermined volume has been reached. The volume sensor may measure time the valve is open and an amount of transferred water, based on water pressure and pipe size, can be determined. Alternatively, the volume sensor may determine the height of the contents 207 by electronic or other means. A change in volume could be calculated based on the height of the contents 207 before addition of water to the receiver and the height of the contents 207 after the addition of water to the receiver 206. Another example may include the use of a flow sensor in the water transfer 208 to measuring the amount of transferred water for each serving of the heated beverage.

The beverage maker 200 may also comprise a hot water pipe 216 and a receiver contents pipe 218 that join and connect to an output pipe 220. The hot water pipe 216 may be connected to the reservoir 202 such that water may flow from the reservoir 202 through the hot water pipe 216. Once the water reaches the hot water pipe 216, this water may be referred to as the contents of the hot water pipe 217. The flow of contents 217 through the hot water pipe 216 may be gravity or pump driven. Additionally, the receiver contents pipe 218 may be connected to the receiver 206 such that the contents 207 may flow from the receiver 206 through the receiver contents pipe 218. Once the contents 207 reach the receiver contents pipe 218, the contents 207 may be referred to as the contents of the receiver contents pipe 219. The flow of the contents 219 through the receiver contents pipe 218 may be gravity or pump driven.

The output pipe 220 may be connected to the hot water pipe 216 and the receiver contents pipe 218. The output pipe 220 may be positioned below the hot water pipe 216 and the receiver contents pipe 218 such that gravity may pull the contents 219, 217 of the respective pipes 218, 216 into the output pipe 220. Alternatively, the output pipe 220 may be pump driven. A pot or cup may be placed below the output pipe 220 such that contents of the output pipe 221 flow out of the output pipe 220 as the heated beverage 224 after dispensing into the pot or cup 226 is completed. For example, the preparation of the heated beverage 224 may be completed before dispensing from the output pipe 220. Alternatively, the contents of the output pipe 221 may be further dilute by previously and/or subsequently dispensing water into the cup 226 to form the heated beverage 224 in the cup 226. For example, subsequent dispensing of water may also provide a cleaning function within the beverage maker 200, such that subsequent flavors or drink may be prepared without noticeable contamination by previous flavors. For example, subsequent dispensing of water may occur by dispensing water through water transfer 208, through the receiver 206, through the receiver contents pipe 219, and through the output pipe 221 for cleaning of one or more of each.

Pipes 216 and 218 may have a reservoir release 224 and a receiver release 222, respectively. The reservoir release 224 and the receiver release 222 may be configured such that they do not allow fluid to flow out of the respective reservoir 202 and receiver 206 in their respective default positions. However, the reservoir release 224 may be manipulated to an open position to allow water 203 from the reservoir 202 into the hot water pipe 216, whereby the water 203 becomes at least part of the contents of the hot water pipe 217. Additionally, the receiver release may be manipulated into an open position to allow contents 207 into the receiver contents pipe 218, whereby the contents 207 become the contents of the receiver contents pipe 219. When both respective releases are open, the contents 219 and 217 may combine in the output pipe 220 or in the cup 226 positioned below the output pipe 220. When the contents 219 and 217 combine in the output pipe 220, the contents are referred to as contents of the output pipe 221. The timing of the respective releases may be adjusted such that a predetermined volume of hot water is allowed to mix with a predetermined amount of contents 207.

Releases 222 and 224 may comprise respective thermometers, volume sensors, or pressure sensors. These sensors may comprise a magnetic level gauge, magnetorestrictive, radiofrequency (RF) transmitter, radar, ultrasonic, magnetic switch, float switch, RF switch, vibrating fork, thermal dispersion, seal pot, or other sensors. The reservoir release sensors may measure temperature of the liquid in the reservoir, volume of liquid in the reservoir, volume of liquid passing through the reservoir release 224, or the pressure of liquid passing through the reservoir release 224. The receiver release sensors may measure temperature of the contents 207, the volume of the contents 207, the volume of contents passing through the receiver release 222, or the pressure of the contents passing through the receiver release 222.

The beverage maker 200 may also comprise a control panel 226. The control panel 226 may accept user input such as time, volume, type of blend, temperature, etc. The control panel 226 may present simplified options such as hot, very hot, or scorching. Furthermore, a simplified option representing volume, such as a button marked “cup” or “pot” may be presented. The “cup” or “pot” option may refer to volumes such as 240 mL and 1000 mL, respectively. When an option is selected, the control panel 226 may provide the corresponding volume as the predetermined serving volume and may calculate the predetermined serving concentration based on the known concentration of the frozen comestible mix 214. The control panel 226 may provide the predetermined serving volume and/or the predetermined serving concentration to one of the other components of the beverage maker 200 or the controller 300. Additionally, embodiments of the beverage maker 200 may accept user input such as the closing of the lid (not shown) to begin preparation of the heated beverage 224. The closing of the lid, or other user actions, may be sensed using magnetic, capacitive, closed circuit, or other sensors.

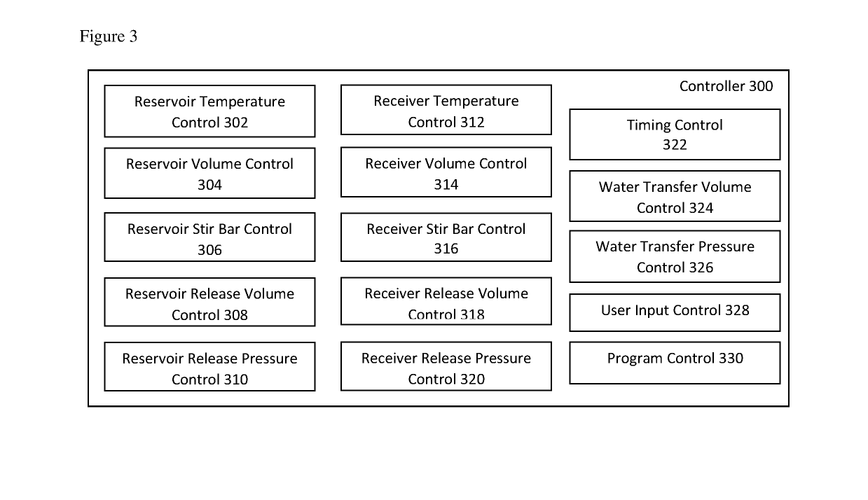

FIG. 3 represents a block-level diagram of a controller 300 according to the teachings of the present invention. The controller 300 may be any device capable of sending and receiving electronic data over an interface. For example, a microcontroller or a computer could be used. The controller 300 may also perform operations on and/or modify the data it receives such that the controls 302-330 may be regulated.

Some embodiments of the beverage maker 300 may have one or more of a reservoir temperature control 302, a reservoir volume control 304, a reservoir stir bar control 306, a reservoir release volume control 308, a reservoir release pressure control 310, a receiver temperature control 312, a receiver volume control 314, a receiver stir bar control 316, a receiver release volume control 318, a receiver release pressure control 320, a timing control 322, a water transfer volume control 324, a water transfer pressure control 326, a user input control 328, and a program control 330.

These respective controls may be embodied on the controller 300. The respective controls may be embodied as hardware circuits or may be software embodiments wherein program code, such as java, C++, etc., manipulates the hardware of a general purpose hardware circuit. Software embodiments may be implemented as low-level code or even as high level code operating within an operating system, such as Unix, BSD, Microsoft Windows, iOS, etc.

Controller 300 may comprise a processing unit (CPU), local memory, peripherals and interfaces, and a general purpose input/output (I/O) interface. The CPU may further comprise local storage. Local storage may be used to store variables, constants, etc. for complex calculations. Local memory may interface with the CPU via a memory interface. The memory interface may allow the CPU to store calculated values, variables, constants, or any other important electronic signal onto the physical local memory. The memory interface may include one or more direct memory access controllers. Of course, part or all of the local memory may be committed to program storage, in which data relevant to the operation of the program is stored. Program storage may also be organized into useful data structures such as a stack or heap. The peripherals and interface and the general purpose I/O interface may interface to external input or output devices. Examples of external input or output devices include any electronic device capable of sending or receiving an electronic signal such as keyboards, mice, printers, scanners, digital sensor, analog sensors, Ethernet, analog to digital converters, ADC, UART, USB etc. Program storage, local memory, peripherals and interface, and general purpose I/O interface may be contained on the circuit board of the CPU. In other embodiments, any of these parts may be external to the CPU.

The reservoir temperature control 302 may be in electronic communication with a thermometer placed to measure the temperature of the fluid in the reservoir 202. The reservoir temperature control 302 may further provide temperature from the communicating thermometer to one or more of the other components of the beverage maker 200 or the controller 300.

The reservoir volume control 304 may be in electronic communication with a sensor configured to provide a volume of fluid in the reservoir 202 to one or more of the other components of the beverage maker 200 or the controller 300. The reservoir volume control 304 may provide a volume of fluid, such as water, in the reservoir 202 to one or more of the other components of the beverage maker 200 or the controller 300. The reservoir stir bar control 306 may be configured to activate and deactivate or to regulate speed of the reservoir stir bar 212. The reservoir release volume control 308 may be configured to activate and deactivate the reservoir release 224 and may further restrict or enable flow of liquid through the reservoir release 224.

Furthermore, the reservoir release volume control 308 may be configured to provide a volume that has passed through the reservoir release 224 to one or more of the other components of the beverage maker 200 or the controller 300. This volume may be determined relative to the start of processing for a serving of the heated beverage, relative to a predetermined time, or relative to an predetermined event, e.g. when a lid of the beverage maker 200 closes, on power on of the beverage maker 200, when a button is depressed, when water is added to the reservoir 202, or when frozen comestible mix is added to the receiver 206. The reservoir release pressure control 310 may be configured to report pressure in the reservoir release 224 and/or pressure in the hot water pipe 216.

The receiver temperature control 312 may be in electronic communication with a thermometer placed to measure the temperature of the contents 207. The receiver temperature control 312 may further provide temperature from the respective communicating thermometer to one or more of the other components of the beverage maker 200 or the controller 300. The receiver volume control 314 may be in electronic communication with a sensor configured to provide a volume of fluid in the receiver 206 to one of the other components of the beverage maker 200 or the controller 300. The receiver volume control 314 may report a volume of the contents 207 to one of the other components of the beverage maker 200 or the controller 300. The receiver stir bar control 316 may be configured to activate and deactivate or regulate a speed of the receiver stir bar 210. The receiver release volume control 318 may be configured to activate and deactivate the receiver release 222 and may further restrict or enable flow through the receiver release 222. Furthermore, the receiver release volume control 318 may be configured to provide a volume that has passed through the receiver release 222. This volume may be determined relative to the start of processing for a serving of the heated beverage, relative to a predetermined time, or relative to an predetermined event, e.g. when a lid of the beverage maker 200 closes, on power on of the beverage maker 200, when a button is depressed, when water is added to the reservoir 202, or when frozen comestible mix is added to the receiver 206. The receiver release pressure control 320 may be configured to provide pressure in the receiver release 224 and/or pressure in the receiver contents pipe 218 to one of the other components of the beverage maker 200 or the controller 300.

The timing control 308 may include a timing circuit in electronic communication with the controller 300. The timing control 308 may provide absolute time, such as UTC or relative time, such as Eastern Time. The timing control may also provide an elapsed time from some starting reference time. The timing control may be in communication with the other controls of the controller 300 such that an elapsed time may be tracked with respect to activation of sensors, such as the thermometer, the heating element 204, etc.

The water transfer volume control 324 may be in electronic communication with a volume sensor configured to measure the volume of fluid passing through the water transfer 208. Furthermore, the water transfer volume control 324 may provide the volume that has passed through the water transfer 208 to one of the other components of the beverage maker 200 or the controller 300. The water transfer volume control 324 may activate or deactivate and increase or decrease the volume of water flowing through the water transfer 208. The water transfer pressure control 326. The water transfer pressure control 326 may be in electronic communication with a pressure sensor configured to measure the pressure of water in the water transfer 208. The water transfer pressure control 326 may report the pressure of the water in the water transfer 208. Furthermore, the water transfer pressure control 326 may activate, deactivate, increase the pressure of, or decrease the pressure of the water transfer 208.

The user input control 328 may be in electronic communication with the control panel 226. The user input control may provide selections made by the user to one of the other components of the beverage maker 200 or the controller 300. For example, the user may select volume, temperature, blend, etc. via the control panel. The user input control may provide these user selections to one of the other components of the beverage maker 200 or the controller 300.

Controls 302-328 may be in electronic communication with the program control 330. Thereby, the program control 330 may receive reported values, such as temperature, pressure, time, and volume, from the respective reporting controls 302-328. Receiving values reported from the controls allows for regulation of the beverage maker 200 for use in preparing a single serve cup of heated beverage or a full pot of heated beverage. Furthermore, the beverage maker 200 may heat various roasts to different respective temperatures. For example, the user may select a dark roast. Absolute time, elapsed time, the start of processing, etc. may cause the program control 330 to receive a low temperature in the reservoir 202. The program control 330 may signal the reservoir temperature control 302 to activate the heating element 204 until a predetermined temperature corresponding with the dark roast is reached. Then, the program control may receive this temperature from the reservoir temperature control 302. The program control 330 may then poll or receive a temperature from the receiver 206. If the temperature is lower in the receiver 206 than the reservoir 202, the program control 330 may signal the water transfer volume control 324 to add water from the reservoir 202 to the receiver 206. The water transfer volume control 324 and the water transfer pressure control 326 may provide volume and pressure of the water added, respectively, to one of the other components of the beverage maker 200 or the controller 300. The program control 330 may also receive the total volume of the receiver 314 via the receiver volume control 314. The program control 330 may regulate the volume of water added to the receiver 206 such that the contents 207 do not become more diluted than the predetermined concentration. In accordance with the pattern above, the program control 330 may receive the temperature of the contents 207. When this temperature matches the predetermined temperature corresponding to the dark roast, the program control 330 may signal the receiver release volume control 318 to activate the receiver release 222 such that the contents 207 flow out of the receiver 206 and ultimately out the output pipe 220. However, other embodiments of the program control 330 also activate the reservoir release volume control 308 to activate the reservoir release 224 such that water flows out the hot water pipe 216 and through the output pipe 220. Thereby, beverage that has not been diluted to the predetermined concentration during heating may be further diluted to reach the predetermined concentration as the heated beverage is served.

Other embodiments of the present invention include the placement of thermometers in any of the heating element 204, the hot water pipe 216, the receiver contents pipe 218, the output pipe 220, and the water transfer 208. Additional embodiments include the placement of multiple thermometers in the various placements described in this detailed description.

The program control 330 may receive a measured temperature from these thermometers. The program control 330 may then compare the measured temperature to the predetermined serving temperature. For example, the measured temperature of the contents 207 may be compared to the predetermined serving temperature. If these respective temperatures are equal, no further heating is required and the contents 207 may be diluted to the serving concentration and served.

Additionally, a plurality of measured temperatures may be received and compared to respective predetermined temperatures. Upon comparison of the measured temperature and the predetermined temperature, the program control 330 may send a signal. For example, if the measured temperature at a thermometer in the reservoir 202 indicates that the temperature of the water is at or above the predetermined serving temperature, the heating element 204 may be deactivated. Furthermore, if the measured temperature of the contents 203 is below the predetermined temperature, the heating element 204 may be activated.

Similarly, the program control 330 may receive measured temperatures from the thermometer in the receiver 206. The temperature control 302 may then compare this measured temperature to the predetermined serving temperature. If the measured receiver temperature is lower than the predetermined serving temperature, the heating element 204 may be activated. Additionally, the water transfer 208 may be activated to transfer hot water from the reservoir 202 directly into the receiver 206. Thereby, the temperature of the contents 207 may be increased, the contents 207 may be diluted, and the volume of the contents 207 may be increased. A plurality of thermometers may be used. The program control 330 may compare the temperature of the contents 207 to the water 203 in the reservoir 202. For example, water from the reservoir 202 may not be added to the receiver 206 until a sufficient temperature difference between the reservoir 202 and the receiver 206 has been reached. Likewise, non-uniformity in temperature measurements may be useful to determine when to activate the stir bars 210 and 212. For example, lack of uniformity of temperature in the reservoir 202 may result in activation of the reservoir stir bar 212. Furthermore, lack of temperature uniformity in the receiver 206 may result in activation of the receiver stir bar 210. Either stir bar 212 or 210 may be deactivated upon detecting the corresponding temperature uniformity.

With regard to addition of water to the receiver 206 via the water transfer 208, any of the timing control, the temperature control, a water volume control, and a water volume control may be used. For example, the timing control may track the amount of time the water transfer 208 is open. Based on the area of the cross section of the water transfer 208, the pressure, and the elapsed time, one of ordinary skill can calculate the volume of water added to the receiver 206. Furthermore, the program control 330 may store the respective temperature, pressure, cross section of the water transfer 208, cross section of the hot water pipe 216, cross section of the receiver contents pipe 218, or cross section of the output pipe 220. Additionally, the program control 330 may perform calculations to determine the pressure and volume of liquid added to the receiver 206. For example, the program control may regulate any of the volume of water added to the receiver 206 via the water transfer 208, the volume of water transferred to the output pipe 220 via the hot water pipe 216, and the volume of contents transferred to the output pipe 220 via the receiver contents pipe 218.

Some values may be input via a control panel 226. For example, the control panel 226 may allow the predetermined serving temperature to be set such that the resulting heated beverage exits the output pipe 220 at a desirable serving temperature. Furthermore, the control panel 226 may set a predetermined serving volume, such as one cup or one pot of heated beverage. The program control 330 may allow storage of predetermined values, such as the predetermined serving temperature, the predetermined serving volume, etc. The program control 330 may store other values, such as constants. Furthermore, the program control 330 may communicate with or facilitate communication between the controls of the controller 300 or sensors.

Embodiments of the present invention allow for control of the temperature at which the heated beverage 224 will be served from the output pipe 220. A user may input the predetermined serving temperature, which may be stored by the controller 300. The predetermined serving temperature may further be stored by the temperature controls 302 or 312. The temperature controls 302 and 312 may also receive temperature data from one or more respective thermometers place in the reservoir 202 and/or in the receiver 206. If the temperature detected by the thermometer is lower than the predetermined serving temperature, the heating element 204 may be activated. If the predetermined serving temperature has been reached, the heating element 204 may be deactivated.

The respective receiver release 222, reservoir release 224, and water transfer 208 may comprise pressure sensors for the determination of the pressure of contents flowing through the respective releases and transfer. The measured pressure may be communicated to the controller 300, and more specifically, may be stored by the program control 330.

If all of the conditions of volume, temperature, and/or time have been met, the releases 222, 224 may be activated. For example, the water transfer 208 may transfer water if the water of the reservoir 202 is hotter than the temperature of the contents 207. Furthermore, the reservoir release 224 may be activated to transfer a predetermined volume of water, based on the cross section and pressure of the hot water pipe 216 as well as the elapsed time of transfer. Likewise, the receiver release 222 may be activated to transfer a predetermined volume of contents 207, based on the cross section and pressure of the receiver contents pipe 218 and the elapsed time of transfer. For example, the frozen comestible mix 214 may be concentrated three times a desired serving concentration. In this case, the receiver release 222 may transfer a first volume of contents 207. The reservoir release 224 may then transfer a second volume of water, wherein the second volume is double the first volume. In this manner, the contents 207 may be diluted to one third of the concentration such that the coffee is served at the desired serving concentration.

What is claimed is:

1. A beverage maker, comprising:
a receiver comprising a hollow body comprising an interior surface and an exterior surface, wherein the hollow body is configured to retain contents;
a reservoir configured to retain fluid;
a fluid transfer configured to transfer fluid from the reservoir to the receiver;
a heating element in thermal communication with at least one of the reservoir and the receiver; and
at least one pipe configured to receive contents from the receiver, wherein the at least one pipe is configured to dispense the contents from the beverage maker.

2. The beverage maker of claim 1, wherein the reservoir is at least partially formed around the receiver such that the receiver is in thermal communication with the reservoir.

3. The beverage maker of claim 2,
wherein the heating element is positioned within the reservoir.

4. The beverage maker of claim 1,
wherein the fluid transfer is configured to transfer hot water to the receiver.

5. The beverage maker of claim 1, further comprising
a thermometer in thermal communication with the contents of the receiver.

6. The beverage maker of claim 5, wherein the beverage maker is configured to dispense the contents at a predetermined temperature.

7. The beverage maker of claim 1, further comprising:
a timing circuit configured to activate the heating element at a predetermined first elapsed time,
wherein the timing circuit is configured to deactivate the heating element at a predetermined second elapsed time.

8. The beverage maker of claim 1, further comprising
a timing circuit configured to activate the heating element at a predetermined time,
wherein the timing circuit is configured to deactivate the heating element at a predetermined elapsed time.

9. The beverage maker of claim 1, further comprising
a thermometer in thermal communication with the reservoir.

10. The beverage maker of claim 9,
wherein the heating element is configured to heat a contents of the reservoir to a predetermined first temperature,
wherein the fluid transfer is configured to transfer the contents of the reservoir to the receiver after the contents of the reservoir have been heated to the predetermined first temperature, and
wherein the beverage maker is configured to dispense the contents of the receiver at a predetermined second temperature.

11. The beverage maker of claim 1, further comprising
a frozen comestible mix in the receiver.

12. A method of making a heated beverage, comprising:
retaining a frozen comestible mix in a receiver such that the frozen comestible mix becomes at least part of a contents of the receiver;
heating the contents of the receiver; and
dispensing the heated contents through an output pipe.

13. The method of claim 12, further comprising:
dispensing water to dilute the contents of the receiver,
wherein the frozen comestible mix is a concentrate sufficient to form a potable beverage by dilution.

14. The method of claim 13,
wherein the frozen comestible mix is double a predetermined concentration of the heated beverage, and
wherein sufficient water is dispensed such that the predetermined concentration of heated beverage is made.

15. The method of claim 13,
wherein the frozen comestible mix is triple a predetermined concentration of the heated beverage, and
wherein sufficient water is dispensed such that the predetermined concentration of heated beverage is made.

16. The method of claim 12, further comprising
forming the frozen comestible mix by dripping a liquid comestible mix into liquid nitrogen before adding the frozen comestible mix to the receiver.

17. The method of claim 12, wherein heating the contents of the receiver comprises adding a heated fluid to the contents of the receiver.

18. The method of claim 12, wherein the frozen comestible mix comprises a frozen coffee mix.

19. The method of claim 12, wherein the frozen comestible mix comprises a frozen tea mix.

20. The method of claim 12, further comprising
dispensing water out of the output pipe, comprising pressure spraying a predetermined dilution volume of water onto an interior of the receiver and then dispensing the dilution volume of water through the output pipe,
wherein dispensing water occurs after dispensing the heated contents.
